(19) United States
(12) Patent Application Publication
(10) Pub. No.: US 2009/0234576 A1
(43) Pub. Date: Sep. 17, 2009

(54) NAVIGATION DEVICE AND METHOD

(75) Inventors: WEN-CHIN OU, Tu-Cheng (TW); MING-LIANG YANG, Tu-Cheng (TW); GUO-JHANG CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/403,383

(22) Filed: Mar. 13, 2009

(30) Foreign Application Priority Data
Mar. 14, 2008 (CN) 200810300584.9

(51) Int. Cl. G01C 21/00

(52) U.S. Cl. 701/201; 701/200; 701/208

(57) ABSTRACT

A navigation device includes a transceiver, a timer, an angle detector, and a processor. The transceiver is for projecting a detecting signal and receiving the detecting signal reflected from an obstacle in front of the transceiver. The timer is for calculating a time interval between projecting the detecting signal and receiving the detecting signal reflected from the obstacle. The angle detector is for detecting a projecting angle of the detecting signal projected from the transceiver with respect to the vertical direction. The processor is for calculating a horizontal distance to the obstacle according to a velocity of the detecting signal, the time interval, and the projecting angle.

### BACKGROUND

1. Technical Field

The present disclosure generally relates to navigation, and particularly relates to a navigation device and method for use by the visually impaired.

2. Description of Related Art

Navigation devices are widely used to help the visually impaired. A popular navigation device is an electronic talking stick which outputs audio instructions for walking such as ascending and descending stairways. The electronic talking stick also warns a visually impaired individual of impending danger, such as depressions and obstacles in a pathway being traversed, and if need be the electronic walking stick can even call for help. However, most electronic talking stick are limited to obtaining the distance to the potential dangerous objects, and cannot measure the heights or depths or other parameters of the depressions or obstacles in the pathway.

Therefore, a navigation device and a navigation method are needed in the industry to address the aforementioned deficiency.

### BRIEF DESCRIPTION OF THE DRAWINGS

FIG. 1 is a schematic block diagram showing a navigation device in accordance with an exemplary embodiment.

FIG. 2 is a schematic diagram showing a mathematic model for illustrating a working principle of the navigation device in FIG. 1.

FIG. 3 is a schematic diagram showing a positive situation of the mathematic model.

FIG. 4 is a schematic diagram showing a negative situation of the mathematic model.

FIG. 5 is a schematic diagram showing an irregular object measured by the navigation device.

FIG. 6 is a schematic diagram showing an irregular recess measured by the navigation device.

FIG. 7 is a schematic diagram showing an incline measured by the navigation device.

FIG. 8 is a schematic diagram showing a decline measured by the navigation device.

FIG. 9 is a schematic diagram showing a wall measured by the navigation device.

FIG. 10 is a schematic block diagram showing a navigation device in accordance with another exemplary embodiment.

FIG. 11 is a schematic block diagram showing a navigation device in accordance with another exemplary embodiment.

FIG. 12 is a schematic block diagram showing a digital map used by the navigation device in FIG. 10.

FIG. 13 is a flowchart showing a navigation method in accordance with an exemplary embodiment.

FIG. 14 is a flowchart showing a navigation method in accordance with an exemplary embodiment.

### DETAILED DESCRIPTION

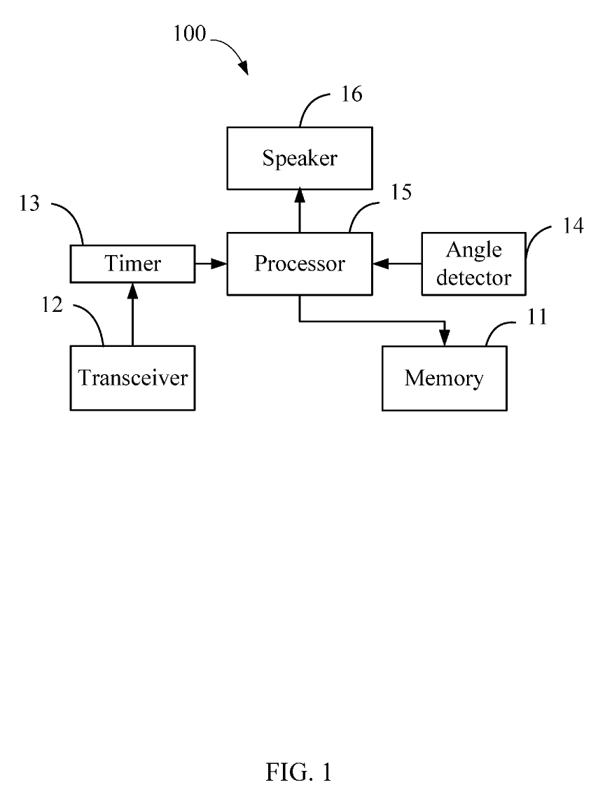

Referring to FIG. 1, a navigation device 100 in accordance with an exemplary embodiment is capable of aiding the visually impaired with audio alerts. The navigation device 100 includes a memory 11, a transceiver 12, a timer 13, an angle detector 14, a processor 15, and a speaker 16.

The memory 11 stores an alerting program and a predetermined safe value. The transceiver 12 projects a detecting signal repeatedly at predetermined time intervals, receives the detecting signal reflected from obstacles. The timer 13 calculates a time interval between projecting the detecting signal and receiving the detecting signal reflected from the obstacles. The angle detector 14 detects a projecting angle of the detecting signal projected from the transceiver 12 with respect to the vertical direction. The processor 15 calculates a horizontal distance to the obstacle and a size of the obstacle (a height of an object or a depth of a recess), and calls the alert program from the memory 11 to generate an alert signal according to the horizontal distance and the size. The speaker 16 reproduces an audio alert according to the alert signal.

The angle detector 14 may be a magnetic-sensing resistor. When the angle detector 14 is rotated, the magnetic-sensing resistor can detect an angular displacement of the magnetic field, convert the angular displacement to an electrical signal, and calculate the projecting angle according to the electrical signal. The angle detector 14 may include an angle counter (not shown). When the angle detector 14 is rotated by a predetermined angle perpendicular to gravity, the angle counter will increment by a constant. When the angle detector 14 is turned to another direction opposite to the predetermined angle, the angle counter will decrement by the constant. In this way, the angle detector 14 can output the projecting angle via the angle counter. The angle detector 14 may also be a liquid level measuring apparatus which measures a rotated angle according to a liquid level variance of the liquid level measuring apparatus.

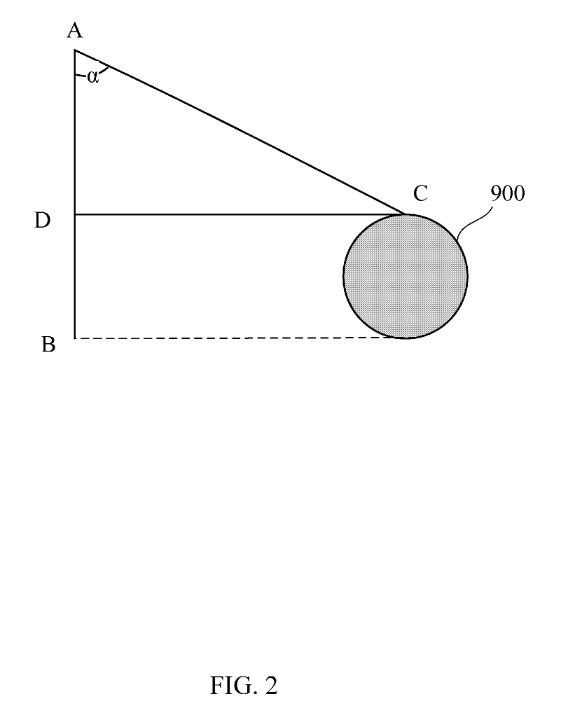

Referring to FIG. 2, a schematic diagram illustrates how the processor 15 calculates the horizontal distance to an obstacle 900 and the size of the obstacle 900. The obstacle 900 shown as a circle on the ground provides a first example of a mathematic model for calculating the horizontal distance and the size. In the first example: a velocity “V” of the detecting signal is known, a time interval “T” between projecting the detecting signal and receiving the detecting signal reflected from obstacle 900 is measured, a projecting angle “α” of the detecting signal with respect to the vertical direction, and a height “AB” of the navigation device 100 with respect to the ground is measured.

According to diagram, the detecting signal projected and the detecting signal reflected are transmitted between a point A (the position of the navigation device 100) and a point C. The distance between the point A and the point C can be calculated applying a first equation “AC=V*T/2”. Therefore, the horizontal distance, from a point D to the point C, can be calculated applying a second equation “DC=AC*sin ∠α=(V*T*sin ∠α)/2”. The size of the obstacle 900, the same as a height from the point D to the point B, can be calculated applying a third equation “DB=AB−AD=AB−AC*cos ∠α=AB−(V*T*cos ∠α)/2”.

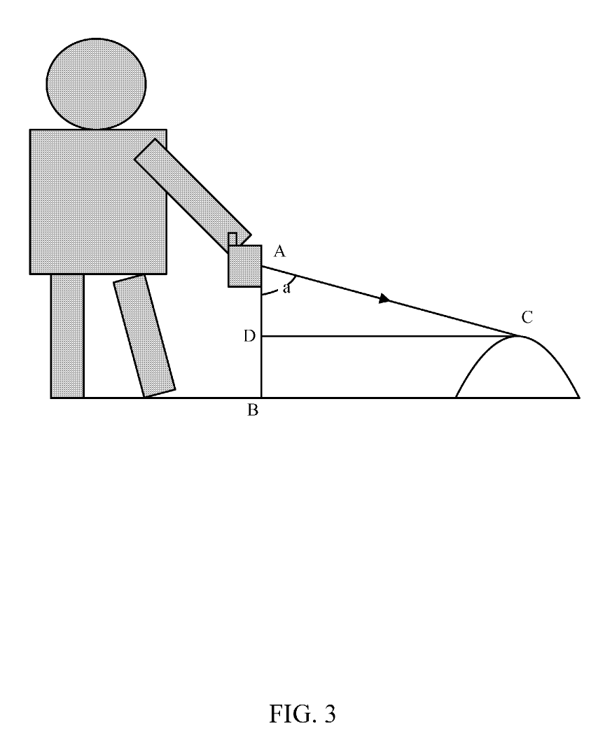

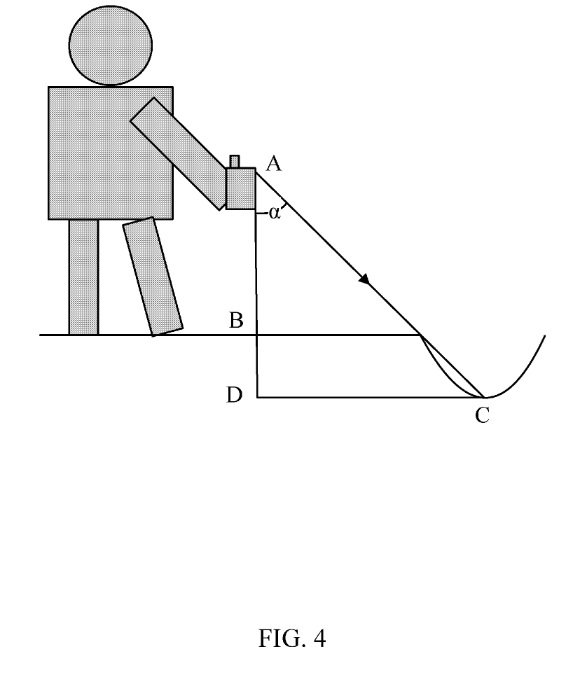

The processor 15 compares an absolute value of the size DB with the predetermined safe value stored in the memory 11. If the absolute value does not exceed the predetermined safe value, the navigation device 100 makes no response and continues to project the detecting signal. If the absolute value exceeds the predetermined safe value, the processor 15 determines whether the size DB is positive or negative. If the size DB is positive, that means the obstacle is an object on the ground (see FIG. 3), and the processor 15 will generate a positive signal. If the size DB is negative, that means the obstacle is a recess below the ground (see FIG. 4), and the processor 15 will generate a negative signal.

The processor 15 calls the alerting program to generate an alert signal. The alert signal includes data indicating the horizontal distance DC, the size DB, and the positive/negative signal. The speaker 16 reproduces an audio alert according to the alert signal. For example, the speaker 16 may reproduce “there is a DB meter high object DC meters from here”.

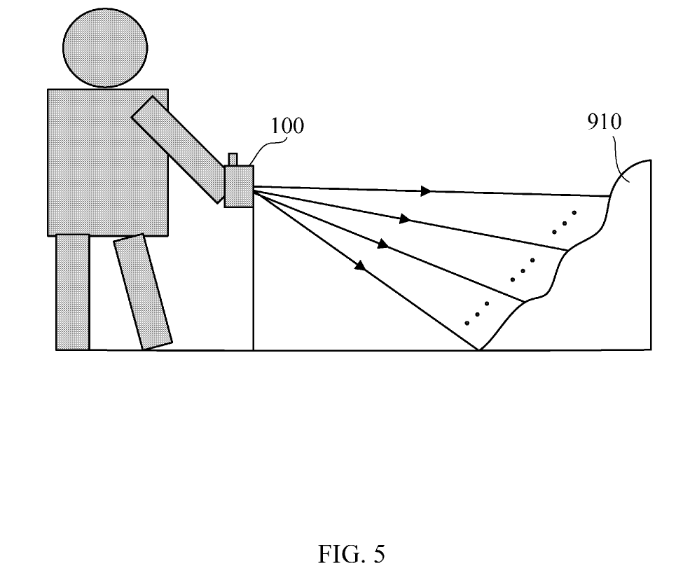

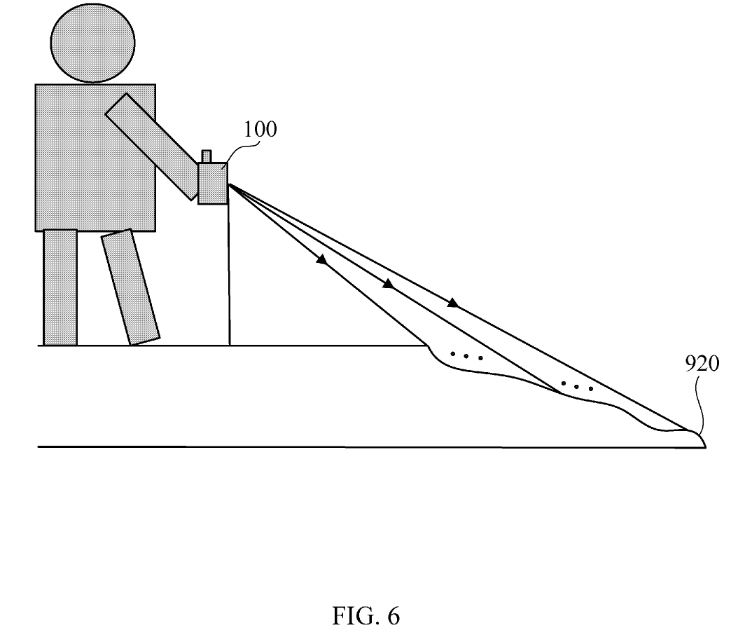

Referring to FIG. 5, the navigation device 100 is used to get information of an irregular object 910 to depict its profile. The navigation device 100 is used to measure each point of the irregular object 910. In operation, the navigation device 100 scans the irregular object 910 by projecting a detecting signal to each point of the irregular object 910 and receiving the detecting signal. For each point of the irregular object 910, the navigation device 100 uses the same method as detailed above in calculating information of the point C of the obstacle 900 in FIG. 2. Similarly, also referring to FIG. 6, the navigation device 100 is also used to get information of an irregular recess 920 to depict its profile. In operation, the navigation device 100 scans the irregular recess 920 by projecting a detecting signal to each point of the irregular recess 920 and receiving the detecting signal reflected therefrom. For each point of the irregular recess 920, the navigation device 100 uses the same method as detailed above in calculating information of the point C of the obstacle 900 in FIG. 2.

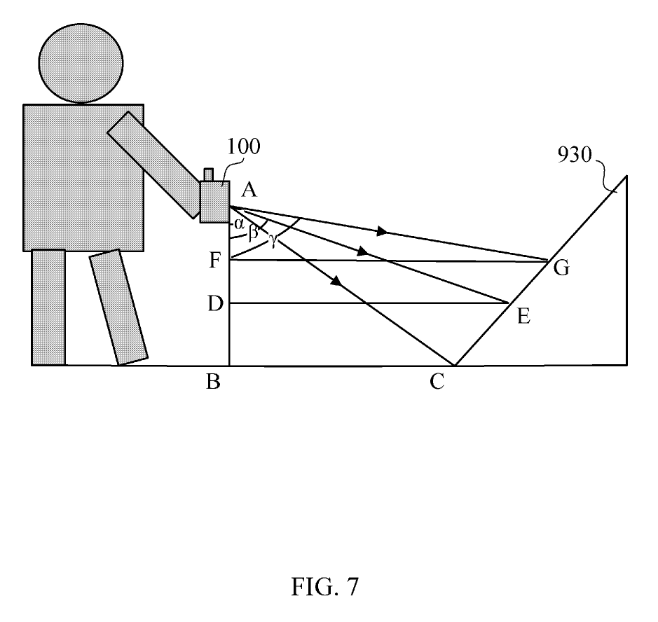

Furthermore, when the navigation device 100 is used for measuring some regular obstacles, the navigation device 100 measures some key points rather than each point of the obstacles to get basic information of the obstacles. Some actual instances are set forth in FIGS. 7-9. FIG. 7 shows an incline 930 in front of the navigation device 100. The navigation device 100 measures three points C, E, G of the incline 930. For the three points, there are corresponding projecting angles α, β, γ, and time intervals T1, T2, T3. Therefore, horizontal distances of the points C, E, G are “BC=(V*T1*sin ∠α)/2”, “DE=(V*T2*sin ∠β)/2”, “FG=(V*T3*sin ∠γ)/2”, and heights of the points C, E, G are “0”, “DB=AB−(V*T2*cos ∠β)/2”, “FB=AB−(V*T3*cos ∠γ)/2”. If FB>DB>0 and FG>DE>BC, the processor 15 generates an alert signal to inform the visually impaired of the incline 930. The speaker 16 may reproduce “there is an incline BC meters from here”.

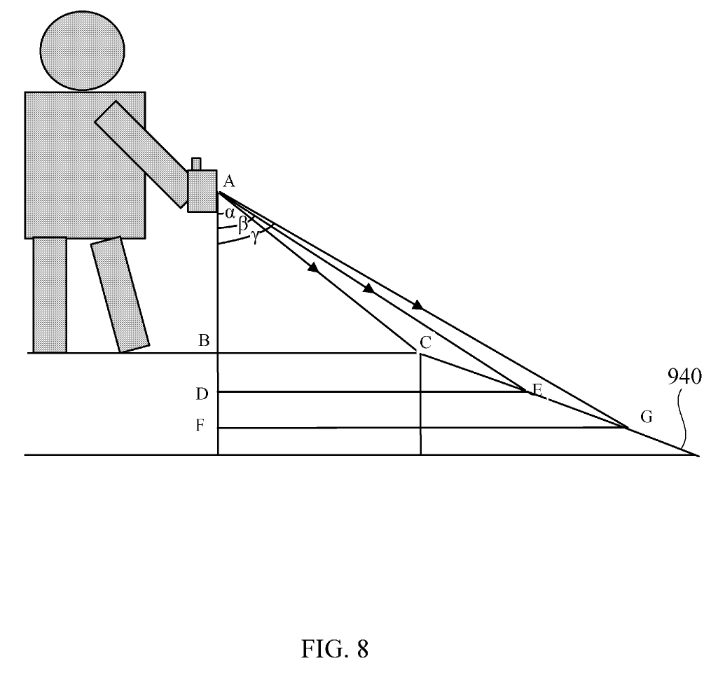

FIG. 8 shows a decline 940. The navigation device 100 measures three points C, E, G of the decline 940. For the three points, there are corresponding projecting angles α, β, γ, and time intervals T1, T2, T3. Therefore, horizontal distances of the points C, E, G are “BC=(V*T1*sin ∠α)/2”, “DE=(V*T2*sin ∠β)/2”, “FG=(V*T3*sin ∠γ)/2”, and depths of the points C, E, G are “0”, “DB=AB−(V*T2*cos ∠β)/2”, “BF=AB−(V*T3*cos ∠γ)/2”. If FB<DB<0 and FG>DE>BC, the processor 15 generates an alert signal to inform the visually impaired of the decline 940. The speaker 16 may reproduce “there is a decline BC meters from here”.

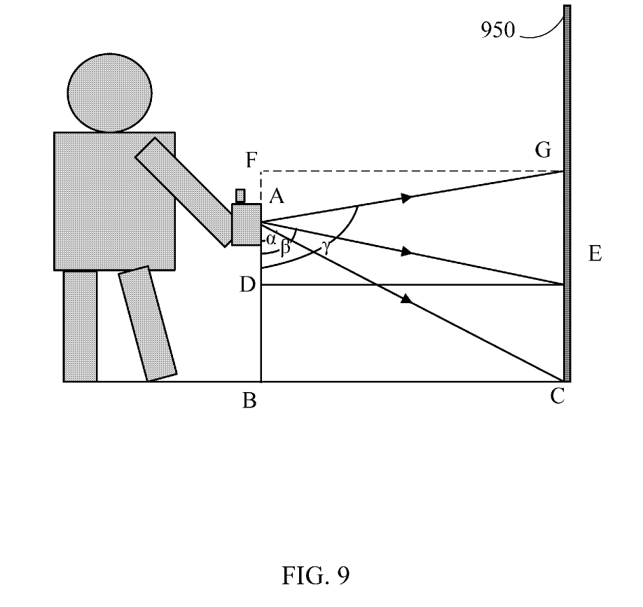

FIG. 9 shows a wall 950. The navigation device 100 measures three points C, E, G of the wall 950. For the three points, there are corresponding projecting angles α, 3, 7, and time intervals T1, T2, T3. Therefore, horizontal distances of the points C, E, G are “BC=(V*T1*sin ∠α)/2”, “DE=(V*T2*sin ∠β)/2”, “FG=(V*T3*sin ∠γ)/2”, and heights of the points C, E, G are “0”, “DB=AB−(V*T2*cos ∠β)/2”, “BF=AB−(V*T3*cos ∠γ)/2”. If FB>DB>0 and FG=DE=BC, the processor 15 generates an alert signal to inform the visually impaired of the wall 950. The speaker 16 may reproduce “there is a wall BC meters from here”.

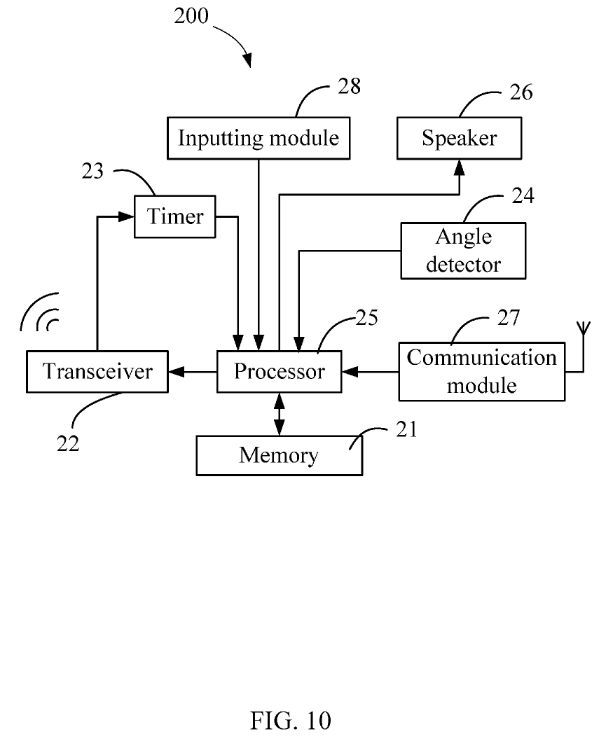

Referring to FIG. 10, a navigation device 200 in accordance with another exemplary embodiment is capable of aiding the visually impaired with not only audio alerting but also routine navigation. The navigation device 200 includes a memory 21, a transceiver 22, a timer 23, an angle detector 24, a processor 25, a speaker 26, a communication module 27, and an inputting module 28. The timer 23 and the angle detector 24 execute the same function as the timer 13 and the angle detector 14 respectively. In comparison with the navigation device 100, the memory 21, the communication module 27, and the inputting module 28 are distinctive and depicted as follows.

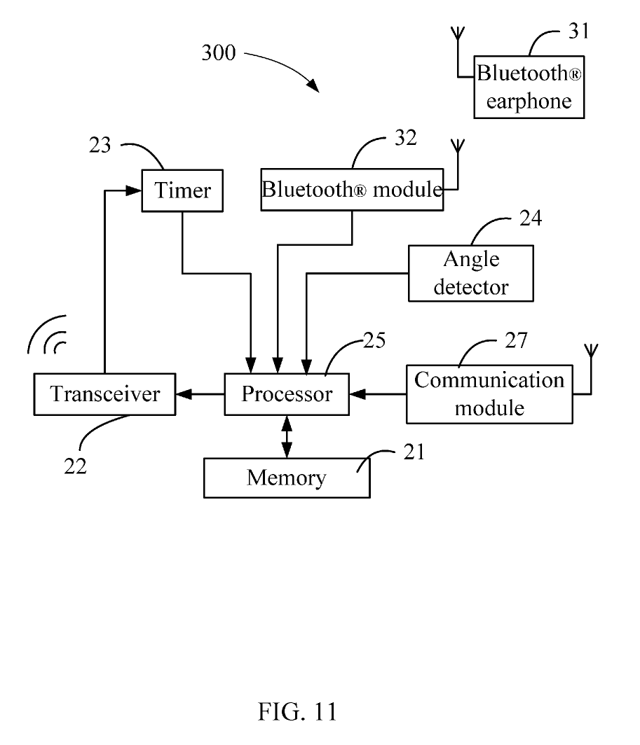

The memory 21 stores not only an alerting program but also a digital map. The inputting module 28 can be used to input a destination. For the visually impaired, the inputting module 28 may be designed as a sound recorder which inputs the destination by recording sound of the visually impaired. The communication module 27 receives a location signal, which indicates a current location of the visually impaired, from satellites. Moreover, the processor 25 searches the destination in the digital map, and then selects an optimum course from the location of the visually impaired to the destination. The processor 25 also calls the alerting program to generate an alert signal according to the optimum course. The speaker 26 reproduces an audio alert according to the alert signal. Moreover, referring to FIG. 11, a navigation device 300 uses a Bluetooth® earphone 31 to replace the speaker 26, and uses a Bluetooth® module 32 to replace the inputting module 28. Therefore, the navigation device 300 can facilitate the visually impaired with a wireless service.

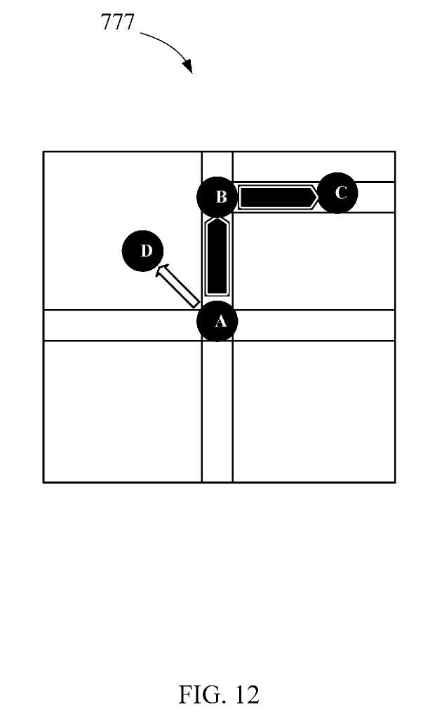

The processor 25 of the navigations 200 also can determine whether the visually impaired strayed from the optimum course. Referring to FIG. 12, a digital map 777 is shown with an optimum course from A-B-C, and a current position is D which is off-course from the line A-B. In this case, the processor 25 calculates an angle between the line A-B and the line A-D. If the angle is beyond a predetermined angle stored in the memory 21, the processor 25 calls the alerting program to generate an alert signal to notice the visually impaired to walk along the optimum course. The speaker 26 reproduces an audio alert according to the alert signal.

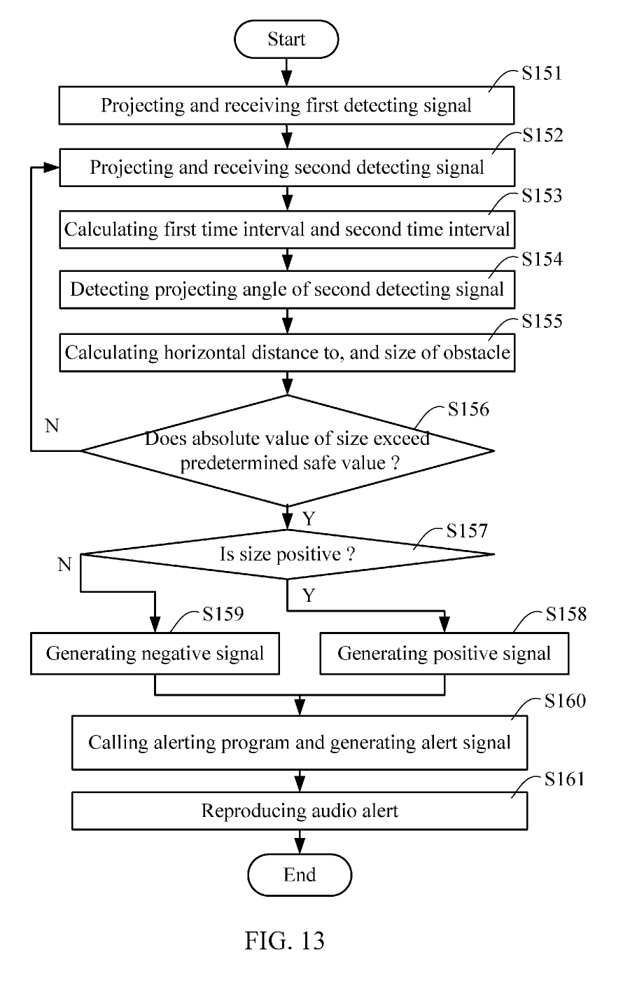

Referring to FIG. 13, a navigation method in accordance with an exemplary embodiment is capable of aiding the visually impaired with an audio alert. Hereafter, the navigation device 100 is taken as a carrier performing the navigation method.

In step S151, the transceiver 12 projects a first detecting signal vertically to the ground, and receives the first detecting signal reflected from the ground.

In step S152, the transceiver 12 projects a second detecting signal forward at predetermined intervals, and receives the second detecting signal reflected from an obstacle.

In step S153, the timer 13 calculates a first time interval between projecting and receiving in step S151, and calculates a second time interval between projecting and receiving in step S152.

In step S154, the angle detector 14 detects a projecting angle of the second detecting signal projected from the transceiver 12 with respect to the vertical direction.

In step S155, the processor 15 calculates a horizontal distance to the obstacle and a size of the obstacle according to the first time interval, the second time interval, a first velocity of the first detecting signal, a second velocity of the second detecting signal, and the projecting angle. In the embodiment, the first detecting signal and the second detecting signal have the same velocity. In other embodiments, they may have different velocities.

In step S156, the processor 15 compares an absolute value of the size of the obstacle with a predetermined safe value. If the absolute value does not exceed the predetermined safe value, step S152 is next. If the absolute value exceeds the predetermined safe value, step S157 is next.

In step S157, the processor 15 determines whether the size is positive or negative. If the size is positive, step S158 is next. If the size is negative, step S159 is next.

In step S158, the processor 15 generates a positive signal.

In step S159, the processor 15 generates a negative signal.

In step S160, the processor 15 calls the alerting program to generate an alert signal according to the horizontal distance, the size, and the positive/negative signal.

In step S161, the speaker 16 reproduces an audio alert according to the alert signal.

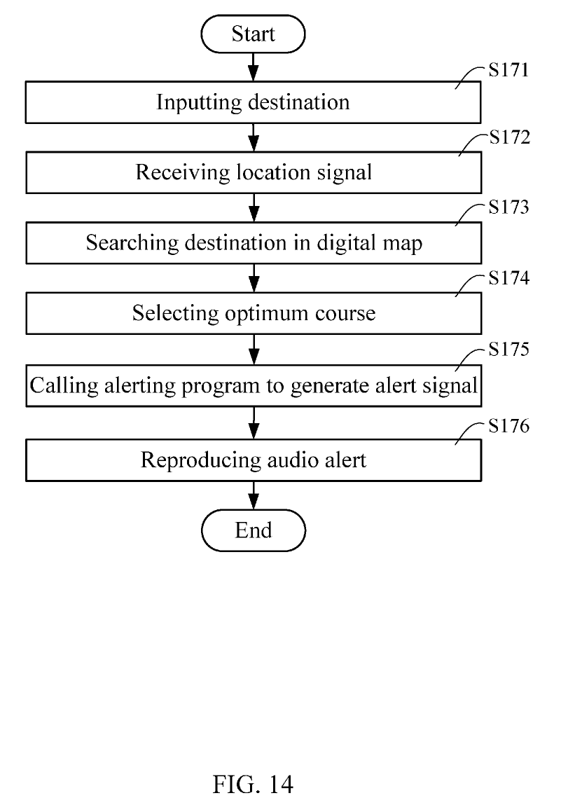

Referring to FIG. 14, a navigation method in accordance with another exemplary embodiment is capable of aiding the visually impaired with routine navigation. Detailed steps of the navigation method used by a navigation device (the navigation device 200 for example) are set forth as follows.

In step S171, the inputting module 28 inputs a destination.

In step S172, the communication module 27 receives a location signal indicating a location of the visually impaired from satellites.

In step S173, the processor 25 searches the destination in a digital map.

In step S174, the processor 25 selects an optimum course from the location to the destination.

In step S175, the processor 25 calls the alerting program to generate an alert signal according to the optimum course.

In step S176, the speaker 26 reproduces an audio alert according to the alert signal.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A navigation device comprising:
a transceiver for projecting a detecting signal and receiving the detecting signal reflected from an obstacle in front of the transceiver;
a timer for calculating a time interval T between projecting the detecting signal and receiving the detecting signal;
an angle detector for detecting a projecting angle α of the detecting signal projected from the transceiver with respect to the vertical direction; and
a processor for calculating a horizontal distance to the obstacle according to a velocity V of the detecting signal, the time interval T, and the projecting angle α.

2. The navigation device according to claim 1, wherein the horizontal distance is calculated according to: the horizontal distance=V*T*(sin ∠α)/2.

3. The navigation device according to claim 1, wherein the processor is for calculating a size of the obstacle according to: the size=a height of the navigation device−(V*T*cos ∠α)/2.

4. The navigation device according to claim 1, wherein the angle detector is a magnetic-sensing resistor.

5. The navigation device according to claim 1, wherein the angle detector is a liquid level measuring apparatus.

6. The navigation device according to claim 1, further comprising a memory for storing an alerting program and a predetermined safe value.

7. The navigation device according to claim 6, wherein the processor is also for calling the alerting program to generate an alert signal according to the horizontal distance.

8. The navigation device according to claim 7, further comprising a speaker for reproducing an audio alert according to the alert signal.

9. The navigation device according to claim 6, wherein the memory is also for storing a digital map.

10. The navigation device according to claim 9, further comprising an inputting module for inputting a destination.

11. The navigation device according to claim 10, further comprising a communication module for receiving a location signal indicating a current location of the navigation device from satellites.

12. The navigation device according to claim 11, wherein the processor is for searching the destination in the digital map, and selecting an optimum course from the location to the destination.

13. The navigation device according to claim 12, wherein the processor is also for calling the alerting program to generate an alert signal according to the optimum course.

14. The navigation device according to claim 13, further comprising a speaker for reproducing an audio alert according to the alert signal.

15. A navigation method comprising:
projecting a first detecting signal, and receiving the first detecting signal reflected from an obstacle;
calculating a first time interval between projecting the first detecting signal and receiving the first detecting signal;
detecting a projecting angle of the first detecting signal with respect to the vertical direction; and
calculating a horizontal distance to the obstacle according to the first time interval, a velocity of the first detecting signal, and the projecting angle.

16. The navigation method according to claim 15, further comprising:
projecting a second detecting signal vertically to the ground, and receiving the second detecting signal reflected from the ground;
calculating a second time interval between projecting and receiving the second detecting signal; and
calculating a size of the obstacle according to the first time interval, the second time interval, a first velocity of the first detecting signal, a second velocity of the second detecting signal, and the projecting angle.

17. The navigation method according to claim 16, further comprising:
comparing an absolute value of the size of the obstacle with a predetermined safe value; and
going to step “projecting a first detecting signal, and receiving the first detecting signal reflected from an obstacle” if the absolute value does not exceed the predetermined safe value.

18. The navigation method according to claim 17, further comprising:
determining whether the size is positive or negative if the absolute value exceed the predetermined safe value;
generating a positive signal if the size is positive;
generating a negative signal if the size is negative;
calling the alerting program to generate an alert signal according to the horizontal distance, the size, and the positive/negative signal; and
reproducing an audio alert according to the alert signal.

19. The navigation method according to claim 15, further comprising:
inputting a destination;
receiving a location signal from satellites;
searching the destination in a digital map; and
selecting an optimum course from the location to the destination.

20. The navigation method according to claim 19, further comprising:
calling the alerting program to generate an alert signal according to the optimum course; and
reproducing an audio alert according to the alert signal.
